(19) United States
(12) Patent Application Publication
(10) Pub. No.: US 2026/0217583 A1
(43) Pub. Date: Jul. 30, 2026

(54) WATER PREPARATION FOR MEDICAL USE

(71) Applicant: GAMBRO LUNDIA AB, Lund (SE)

(72) Inventors: Cristina Scret, Dalby (SE); Helena Jeppsson, Hörby (SE)

(21) Appl. No.: 19/141,707

(22) PCT Filed: Dec. 20, 2023
(86) PCT No.: PCT/EP2023/086904

§ 371 Date: Jun. 20, 2025

(30) Foreign Application Priority Data
Dec. 20, 2022 (SE) 2251497-0

(51) Int. Cl. C02F 9/00; C02F 1/28; C02F 1/32; C02F 1/42; C02F 1/44; C02F 101/12

(52) U.S. Cl. CPC C02F 9/00; C02F 1/283; C02F 1/32; C02F 1/42; C02F 1/441; C02F 2101/12; C02F 2201/007; C02F 2201/326; C02F 2209/003; C02F 2209/005

(57) ABSTRACT

An apparatus is operable to prepare water for use in medical treatment based on supply water (W1), for example tap water. The apparatus comprises a filtration device (21) and an irradiation device (22), which are connected in series to sequentially process the supply water (W1) into dechlorinated water (W1′). The filtration device (21) and the irradiation device (22) are redundant in relation to each other, by both being configured to effectively remove the chlorine in the supply water, the filtration device (21) by use of one or more activated carbon filters, and the irradiation device (22) by ultraviolet, UV, irradiation. The combination of different removal techniques in a redundant way relaxes the need for intermittent sampling and analysis of water downstream of the filtration device (21). Further, the operation of the filtration device (21) and/or the irradiation device (22) is monitorable, via the irradiation device (22), for detection of malfunction.

### TECHNICAL FIELD

The present disclosure relates generally to the field of medical treatment, and in particular to a technique of removing chlorine from supply water to produce water for use in medical treatment.

### BACKGROUND ART

Water may be used to produce medical fluids for use in medical treatment. The production of medical fluid may be done centrally or at bedside. The water must meet strict requirements set by standards or guidelines, in terms of both sterility and content of potentially harmful substances. The water may be produced from tap water by a dedicated water preparation apparatus with purification equipment that operates by reverse osmosis and/or ion exchange. This purification equipment is highly sensitive to chlorine, which is normally present in tap water. Therefore, the water preparation apparatus may include a pre-processing stage for removing chlorine from the incoming water by filtration through activated carbon. To mitigate the risk for so-called channeling, in which the incoming water passes the active carbon without being sufficiently dechlorinated, the water preparation apparatus may include two carbon beds that are mutually redundant and connected in series to receive the incoming water. By being redundant, each carbon bed is separately configured to achieve a sufficient dechlorination of the incoming water. The use of dual carbon beds requires frequent manual testing of the filtered water between the carbon beds to ensure that the redundancy is maintained, so as to safeguard the health of both patients and downstream equipment. The testing is costly and time consuming, and involves manual handing of water samples. Currently, there is no equipment that enables automated and cost-effective measurement of chlorine in water.

### SUMMARY

US2013/0126430 discloses a water purification system, in which source water is passed through one or more carbon block filters to remove chlorine and chloramine compounds. A UV device is arranged downstream of the carbon block filter(s) to irradiate the water by UV radiation to ensure the sterility of the water. As far as can be understood, US2013/0126430 also proposes to replace the carbon block filter(s) for a UV device that is configured to achieve both dechlorination and sterilization of the source water.

It is an objective to at least partly overcome one or more limitations of the prior art.

One objective is to mitigate the need to manually measure water chlorine content during operation of an apparatus for preparing water for medical use.

One or more of these objectives, as well as further objectives that may appear from the description below, are at least partly achieved by an apparatus for preparing water, a system, and a method of preparing water according to the independent claims, embodiments thereof being defined by the dependent claims.

A first aspect is an apparatus for preparing water for use in medical treatment of a human or animal body. The apparatus is configured to receive supply water from a water source. The apparatus comprises: a filtration device, which is configured to effectively remove chlorine in the supply water by use of one or more activated carbon filters; and an irradiation device, which is configured to effectively remove the chlorine in the supply water by ultraviolet, UV, irradiation. The filtration device and the irradiation device are connected in series to sequentially process the supply water into dechlorinated water. The apparatus is configured to provide, based on the dechlorinated water, conditioned water for use in the medical treatment.

In some embodiments, the irradiation device comprises a casing, which defines a processing chamber, an inlet to the processing chamber for incoming water, and an outlet from the processing chamber for outgoing water, and the irradiation device further comprises at least one source of UV radiation, which is arranged to irradiate at least part of the processing chamber.

In some embodiments, the irradiation device further comprises at least one sensor, which is arranged to generate a measurement signal indicative of UV radiation intensity in the processing chamber, and the apparatus further comprises a control device, which is configured to receive the measurement signal and monitor operation of at least one of the irradiation device of the filtration device based on the measurement signal.

In some embodiments, the control device is configured to evaluate, based on the measurement signal, the UV radiation intensity in the processing chamber in relation to an intensity limit and generate, when the UV radiation intensity falls below the intensity limit, an alert indicative of a malfunction of the irradiation device.

In some embodiments, the malfunction comprises at least one of a reduction in radiant power of the at least one source of UV radiation, or fouling within the processing chamber.

In some embodiments, the intensity limit corresponds to the irradiation device being operable to effectively remove the chlorine in the supply water.

In some embodiments, the at least one source of UV radiation comprises a light-emitting diode or a laser diode.

In some embodiments, the at least one source of UV radiation comprises a first radiation-emitting element and a second radiation-emitting element, wherein the first and second radiation-emitting elements are configured to emit UV radiation in different wavelength ranges.

In some embodiments, the control device is configured to activate, for removal of the chlorine in the supply water, the first radiation-emitting element, the second radiation-emitting element, or both of the first and second radiation-emitting elements.

In some embodiments, the control device is configured to selectively activate at least one of the first or second radiation-emitting elements based on input data representing a composition of the chlorine in the supply water.

In some embodiments, the first radiation-emitting element is configured for preferential removal of monochloramine over free chlorine and dichloramine, and the second-emitting element is configured for preferential removal of free chlorine and dichloramine over monochloramine.

In some embodiments, the first radiation-emitting element is configured to generate UV radiation with a peak in a first wavelength range of 240-265 nm, and the second-emitting element is configured to generate UV radiation with a peak in a second wavelength range of 265-290 nm.

In some embodiments, the at least one source of UV radiation is configured to generate UV radiation within a wavelength range of 100-400 nm, and preferably within a wavelength range of 200-325 nm.

In some embodiments, the irradiation device is configured to operate with a continuous flow of water through the processing chamber, from the inlet to the outlet.

In some embodiments, the control device is configured to detect channel formation in the one or more activated carbon filters of the filtration device based on the measurement signal; and generate an alert signal upon detection of the channel formation.

In some embodiments, the control device, for said detection of the channel formation, is configured to evaluate the measurement signal for detection of a step-change decrease in the measurement signal.

In some embodiments, the control device is configured to detect the step-change decrease by comparing a signal level in the measurement signal to a threshold value.

In some embodiments, the control device is configured to, at a current time point, determine a reference level as a function of preceding signal values in the measurement signal; set the threshold value in relation to the reference level; and compare the signal level in the measurement signal at the current time point to the threshold value.

In some embodiments, the irradiation device comprises a further source of UV radiation and a further sensor, which are arranged downstream of said at least one source and said sensor, the further sensor is arranged to generate a further measurement signal indicative of UV radiation intensity received from the further source, and the control device is configured to detect the channel formation based on the measurement signal and the further measurement signal.

In some embodiments, the control device, for said detection of the channel formation, is configured to evaluate the further measurement signal for detection of a further step-change decrease in the further measurement signal.

In some embodiments, the control device is configured to generate the alert signal when the further step-change decrease in the further measurement signal is detected in time synchronization with a corresponding step-change decrease in the measurement signal.

In some embodiments, the filtration device is arranged upstream of the irradiation device.

In some embodiments, the filtration device and the irradiation device are included in a pre-processing sub-system, and the apparatus further comprises a main sub-system, which is arranged to receive the dechlorinated water from the pre-processing subsystem and configured to process the dechlorinated water for generation of the conditioned water.

In some embodiments, the main sub-system comprises at least one of reverse osmosis equipment or ion exchange equipment.

In some embodiments, the filtration device and the irradiation device are connected in series without intervening processing equipment for removal of chlorine.

In some embodiments, the apparatus is configured to supply the conditioned water to a dialysis apparatus.

In some embodiments, the filtration device contains a single activated carbon filter, which is configured to effectively remove the chlorine in the supply water.

In some embodiments, the irradiation device is configured for removal of a first target quantity of the chlorine in the supply water, the filtration device is configured for removal of a second target quantity of the chlorine in the supply water, and the second target quantity is at least equal to the first target quantity and less than twice the first target quantity.

A second aspect is a system comprising the apparatus for preparing water in accordance with the first aspect or any of its embodiments, and a dialysis apparatus, which is fluidly connected to receive the conditioned water from the apparatus for preparing water.

A third aspect is a method of preparing water for use in medical treatment of a human or animal body. The method comprises: receiving supply water from a water source; and operating a filtration device and an irradiation device, which are connected in series, to sequentially process the supply water into dechlorinated water, wherein the filtration device is configured to effectively remove chlorine in the supply water by filtration through activated carbon, and wherein the irradiation device is configured to effectively remove the chlorine in the supply water by ultraviolet, UV, irradiation. The method further comprises providing, based on the dechlorinated water, conditioned water for use in the medical treatment.

The embodiments of the first aspect may be adapted as embodiments of the third aspect.

Still other objectives, aspects, embodiments, and technical effects, as well as features and advantages may appear from the following detailed description, from the attached claims as well as from the drawings.

### BRIEF DESCRIPTION OF THE DRAWINGS

FIGS. 1A-1B are schematic views of example systems for dialysis therapy, and FIG. 1C is a block diagram of an example water preparation apparatus for use in the systems of FIGS. 1A-1B.

FIG. 2 is an example of a reference sub-system for removing chlorine from water by activated carbon filtration.

FIG. 3 is a block diagram of an example dechlorination sub-system in a water preparation apparatus in accordance with an embodiment.

FIGS. 4A-4B are section views of an irradiation device and a filtration device in the dechlorination sub-system of FIG. 3 in accordance with embodiments.

FIG. 5 is a graph of absorption spectra for two chloramines with superimposed emission spectra of three example UV-LEDs.

FIG. 6A is a flow chart of an example configuration process for the dechlorination sub-system in FIG. 3, and FIGS. 6B-6D are flow charts of example processes of operating a water preparation apparatus in accordance with embodiments.

FIG. 7 is a schematic view of an example main sub-system in a water preparation apparatus.

FIGS. 8A-8B are graphs of experimental results related to dechlorination by UV radiation.

FIG. 9A shows a first irradiation device, and FIG. 9B is a graph of an example signal from the first irradiation device during channeling in an upstream filtration device.

FIG. 10A shows a second irradiation device, and FIG. 10B is a graph of an example signal from the second irradiation device during channeling in an upstream filtration device.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments.

As used herein, the terms “multiple”, “plural” and “plurality” are intended to imply provision of two or more elements. The term “and/or” includes any and all combinations of one or more of the associated listed elements.

It will furthermore be understood that although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure.

Well-known functions or constructions may not be described in detail for brevity and/or clarity. Unless otherwise defined, all terms (including technical and scientific terms) used herein have the same meaning as commonly understood by one of ordinary skill in the art to which this disclosure belongs.

Like reference signs refer to like elements throughout.

The present disclosure relates to a technique of preparing water for use in medical treatment of a human or animal body. As used herein, a medical treatment is an attempted remediation of a health problem and includes any therapy that brings the water into contact with the body. The present disclosure may be particularly relevant to current or future therapies in which the water is mixed with one or more concentrates, centrally in a clinic or by a machine at bedside, to form a medical fluid that is allowed to interact with the blood of the patient. Such therapies include dialysis therapy, plasmapheresis, apheresis, extracorporeal membrane oxygenation, assisted blood circulation, extracorporeal liver support/dialysis, etc. It is foreseen that this “on-demand generation” of medical fluid will become increasingly common in the future. On-demand generation allows the medical fluid to be generated in the amounts needed and also allows the composition of the medical fluid to be adjusted. Conventionally, pre-made medical fluid is shipped in containers or bags to clinics. On-demand generation reduces the need to stock and handle pre-made medical fluid at the clinic.

As noted, the water preparation technique is applicable to dialysis therapy. As used herein, “dialysis therapy” refers to any therapy that replaces or supplements the renal function of a patient by use of dialysis fluid. Dialysis therapy includes, without limitation, extracorporeal (EC) blood therapy and peritoneal dialysis (PD) therapy.

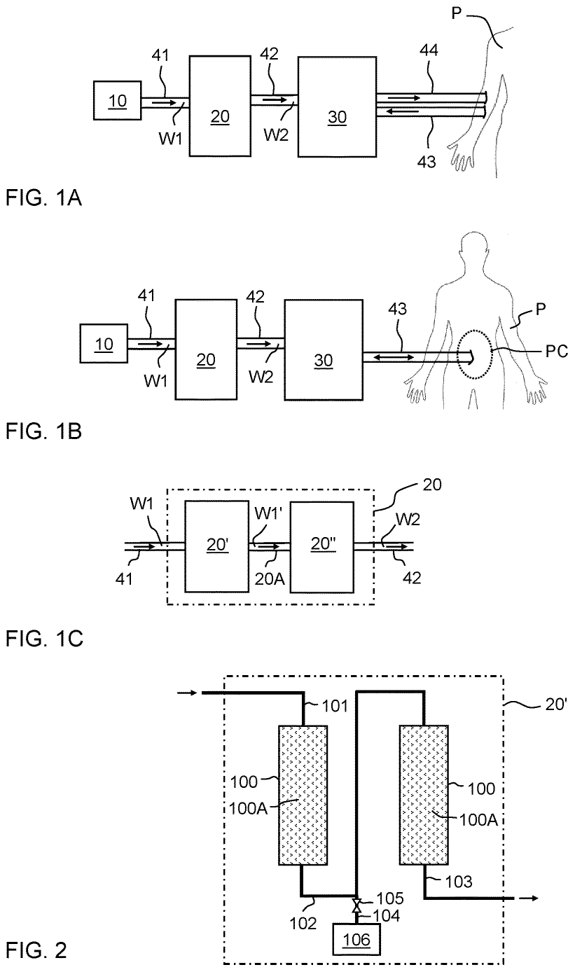

Examples of EC blood therapy include hemodialysis (HD), hemofiltration (HF) and hemodiafiltration (HDF). For context only, fluid generation in relation to EC blood therapy and PD therapy will be briefly discussed with reference to FIGS. 1A-1B.

FIG. 1A is a generic overview of a system for EC blood therapy. The system comprises a water preparation apparatus (WPA) 20 and a dialysis apparatus 30. The WPA 20 is connected by a first fluid line 41 to receive incoming supply water W1 from a water source 10. The supply water W1 may be tap water (drinking water) or some form of pre-processed tap water. The WPA 20 is configured to process W1 into conditioned water W2, which has a sufficient quality for use in EC blood therapy, commonly known as “water for dialysis” (for use in preparation of dialysis fluid, ultrapure dialysis fluid and online prepared substitution fluid). The quality of W2 is given by standards or guidelines, for example ANSI/AAMI/ISO 23500-3:2019. The dialysis apparatus 30 is connected by a second fluid line 42 to receive W2 from the WPA 20. The dialysis apparatus 30 is configured to mix W2 with one or more concentrates to generate a treatment fluid for use in the EC blood therapy, for example a dialysis fluid and/or a replacement fluid. The dialysis apparatus 30 is fluidly connected to the vascular system of a patient P on a fluid path. In the illustrated example, the fluid path is defined by tubing 43 for blood extraction and tubing 44 for blood return. As indicated by arrows, the dialysis apparatus 30 is operable to draw blood from the patient P through tubing 43, process the blood, and return the processed blood to the patient through tubing 44. The tubing 43, 44 is connected to an access device (for example a catheter, graph or fistula, not shown) in fluid communication with the vascular system of the patient P. The dialysis apparatus 30 may be configured to process the blood by use of the treatment fluid. For example, dialysis fluid may be interfaced with blood in a dialyzer and/or replacement fluid may be added to the blood, as is well-known in the art.

FIG. 1B is a generic overview of a system for PD therapy. Like in FIG. 1A, the system comprises a WPA 20, which is configured to generate conditioned water W2 (“water for dialysis” or “water for injection”) from supply water W1, which is received from a water source 10. The quality of W2 may be given by standards or guidelines for PD therapy. A dialysis apparatus 30 is fluidly connected to the peritoneal cavity PC of a patient P. The dialysis apparatus 30 is configured to mix W2 with one or more concentrates to generate a treatment fluid for use in the PD therapy. As indicated by a double-ended arrow, the dialysis apparatus 30 is operable to convey fresh treatment fluid into the peritoneal cavity PC and to receive spent treatment fluid from the PC on a fluid path 43. The fluid path 43 may be defined by tubing that connects to an implanted catheter (not shown) in fluid communication with the PC. The dialysis apparatus 30 may be configured for any type of PD therapy and may comprise a dialysis machine (“cycler”) that performs the dialysis therapy, as is well-known in the art.

FIG. 1C is a generic overview of a water preparation apparatus, WPA, 20, which may be used in the systems of FIGS. 1A-1B as well as in other systems for medical treatment. The WPA 20 comprises a pre-processing sub-system 20′, which is connected to receive supply water W1 on fluid line 41. The sub-system 20′ is configured process W1 for generation of dechlorinated water W1′. The sub-system 20′ is denoted “dechlorination sub-system” in the following. A main sub-system 20″ is connected to receive the dechlorinated water W1′ from the dechlorination sub-system 20′ on a connecting fluid line 20A. The main sub-system 20″ is configured to perform final processing of the dechlorinated water W1′ for generation of the conditioned water W2, which is output on fluid line 42. As understood from the foregoing, W2 is generated with a quality that is acceptable for use in the intended medical treatment. In a non-limiting example, applicable to “water for dialysis”, W2 fulfils the following maximum allowable levels of toxic chemicals: aluminum 0.01 ppm, copper 0.1 ppm, fluoride 0.2 ppm, lead 0.005 ppm, nitrate 2 ppm, sulfite 100 ppm, zinc 0.1 ppm, and total chlorine 0.1 ppm.

The WPA 20 is configured to perform a purification of W1. Water purification is the process of removing undesirable chemicals, biological contaminants, suspended solids, and gases from the water. The major removal of impurities in W1 is performed by the main sub-system 20″. Such impurities include ionic and organic contaminants. The main sub-system 20″ typically includes one or more advanced purification devices, for example using membrane filtration or ion exchange, or a combination thereof. One commonly used membrane filtration technique for water purification is reverse osmosis (RO), in which an RO membrane is used to separate ions, molecules and larger particles from water. Ion exchangers (IEX) are also commonly used for water purification. Simply put, an ion exchanger operates to remove ionic impurities from water by replacing the respective ionic impurity by another ionic substance. Typical ion exchangers are ion-exchange resins (functionalized porous or gel polymer), zeolites, montmorillonite, clay, or soil humus. Electrodeionization (EDI) is also used for water purification. In principle any conventional or future water purification technique may be implemented in the main sub-system 20″ depending on the required quality of W2.

The dechlorination sub-system 20′ is configured to effectively remove chlorine from the supply water W1. As used herein, “effectively remove” implies that the total amount of chlorine in the dechlorinated water W1′ is about 0.1 mg/L (0.1 ppm) or less.

Tap water may contain chlorine, often denoted residual chlorine, as a result of water chlorination performed at the water treatment plant where the tap water is produced. Water chlorination is the process of adding chlorine or chlorine compounds such as hypochlorous acid to water for the purpose of killing bacteria, viruses and other microbes in the water. In particular, chlorination is used to prevent the spread of waterborne diseases such as cholera, dysentery, and typhoid. Residual chlorine is the amount of chlorine that remains in the water after a certain period or contact time, for example 30 minutes. In the US, total chlorine levels of up to 4 mg/L (4 ppm) are considered safe for drinking water. Residual chlorine may be present in free forms and combined forms in chlorinated tap water. The free forms may include dissolved hypochlorite ions, hypochlorous acid and chlorine gas. The combined forms may include chloramines that kill bacteria and oxidize organic matter. Examples of such chloramines include monochloramine, dichloramine and trichloramine. The total amount of chlorine is given by the sum of the free and combined forms of chlorine.

One reason for installing the dechlorination sub-system 20′ upstream of the main sub-system 20″ is to protect the main sub-system 20″ and, by extension, the patient. Many advanced purification devices are sensitive to the strongly oxidizing property of chlorine. For example, the RO membrane in RO equipment is easily and irreversibly damaged by chlorine. Likewise, the ion exchanger in ion exchange equipment may be irreversibly damaged by chlorine. Even if the main sub-system 20″ should be tolerant to chlorine, the dechlorination sub-system 20′ may be installed to reduce the operating demands on the main sub-system 20″. The dechlorination sub-system 20′ need not be configured to only remove residual chlorine, but may also reduce the amount of particles, total dissolved solids (TDS), volatile organic compounds (VOCs), trihalomethanes (THMs), heavy metals, etc., in the supply water W1.

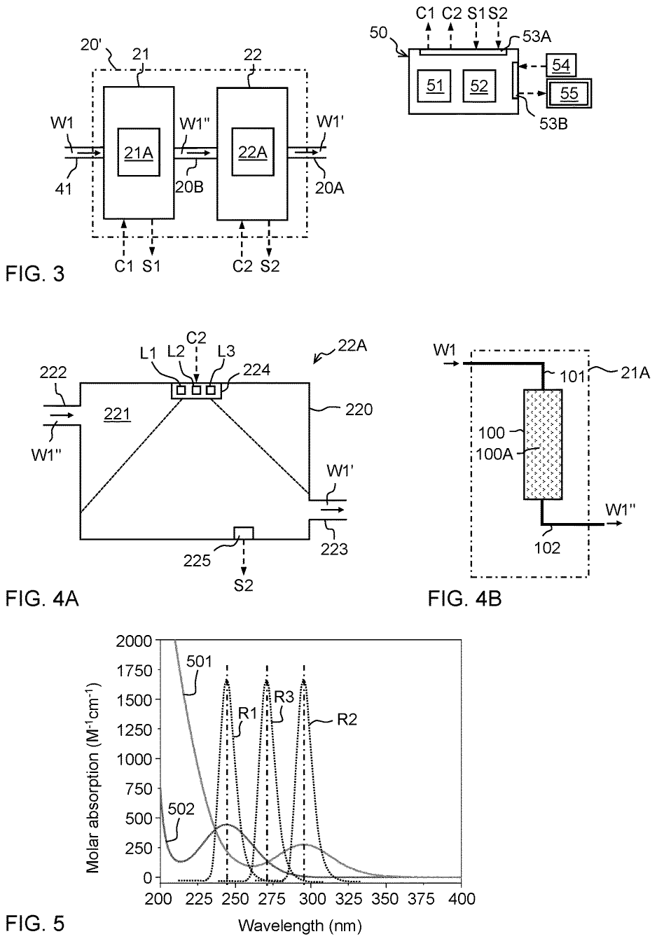

FIG. 2 shows a reference example of a dechlorination sub-system 20′, which operates by passing the supply water through a series of activated carbon (AC) filters 100. The reference example is presented to motivate the technique that is described below with reference to FIGS. 3-6. In FIG. 2, an inlet line 101 is fluidly connected to an inlet of a first AC filter 100, a connecting line 102 is fluidly connected to an outlet of the first AC filter 100 and to an inlet of a second AC filter 100, and an outlet line 103 is fluidly connected to an outlet of the second AC filter 100. Each AC filter 100 is formed by a container that holds activated carbon 100A, also known as active carbon or activated charcoal. The activated carbon 100A has been processed (activated) to have small, low-volume pores that increase the surface area available for adsorption or chemical reactions. The activated carbon 100A forms a bed inside the container. The bed of activated carbon is arranged to remove chlorine from the incoming water, and to absorb toxic substances and pesticides. In an example embodiment, the bed of activated carbon is arranged to remove free and combined forms of chlorine. In a further example embodiment, the bed of activated carbon is also arranged to reduce organic compounds (TOC, total organic carbon) including pesticides of the incoming water.

In the illustrated example, each of the AC filters 100 is separately configured to effectively remove the chlorine in the supply water. The use of two AC filters 100 introduces a redundancy in filtering capacity, to avoid that downstream equipment is irreparably damaged if one of the AC filters 100 malfunctions. For example, a known problem of AC filters 100 is channeling. As water enters the AC filter 100, it automatically flows through the AC filter 100 by the path that presents the least resistance, forming one or more channels through the activated carbon 100A. Channeling is likely to result inadequate removal of chlorine by the AC filter 100. The AC filter 100 is also degraded with use, resulting is decreasing performance over time. Early detection of malfunction is essential in this reference example. The water passing in the connecting line 102 is therefore regularly tested for elevated presence of chlorine. In the illustrated example, a diversion line 104 containing an on/off valve 105 extends from the connecting line 102 to a sampling port 106. A sample of water is taken at the sampling port 106 by opening the on/off valve 105, and the chlorine content of the sample is measured by use of a dedicated measurement device, for example a spectrometer, spectrophotometer or color comparator. Should elevated levels of chlorine be detected in the sample, the first AC filter 100 is discarded and replaced by a new AC filter 100. Typically, a sample is taken and analyzed at the beginning of each day before a patient is first connected for treatment. Sampling and analysis may then be repeated before a new patient is connected, or every 4 hours during operation of the WPA 20. This procedure is both time consuming and costly. The analysis requires specialized and expensive equipment. The taking of samples is labor-intensive. The samples may need to be transported to a central laboratory at the clinic for analysis. The handling of test data from numerous WPAs 20 requires administrative routines to minimize errors.

The present Applicant has found that this cumbersome testing may be obviated or at least reduced in scope by use of a novel concept that involves combining AC filtration with irradiation by ultraviolet (UV) radiation. Specifically, AC filtration and UV irradiation are performed in sequence, where each of the AC filtration and the UV irradiation is sufficient to effectively remove chlorine in the supply water W1. The UV irradiation is thereby redundant in relation to the AC filtration. Thus, the UV irradiation is redundant in the same way as the second (downstream) AC filter 100 in the sub-system 20′ of FIG. 2, with the important difference that the UV irradiation is monitorable. AC filtering is a passive and purely mechanical process and its performance can only be evaluated by water tests. UV irradiation, on the other hand, is an active process that involves generation of UV radiation. The execution of the UV irradiation is monitorable via the generated UV radiation.

FIG. 3 shows an example of a dechlorination sub-system 20′ for use in the WPA 20 in accordance with an embodiment of the foregoing concept. The sub-system 20′ receives supply water W1 on the input line 41 and outputs dechlorinated water W1′ on the connecting fluid line 20A, for receipt by the main sub-system 20″ (FIG. 1C). The sub-system 20′ comprises a filtration device 21 and an irradiation device 22 which are connected in series to sequentially process the supply water W1 into the dechlorinated water W1′. In the illustrated example, the filtration device 21 is arranged upstream of the irradiation device 22 to receive and process the supply water W1. The filtration device 21 comprises a filter module 21A, which is configured to effectively remove chlorine in W1 by filtration through activated carbon. The processing by the filtration device 21 thus results in dechlorinated water, which is denoted “intermediate water” and designated by W1″. A connecting fluid line 20B extends between the filtration device 21 and the irradiation device 22 to convey W1″ to the irradiation device 22. The irradiation device 22 comprises an irradiation module 22A, which is configured to effectively remove chlorine in W1 by UV irradiation. The irradiation device 21 operates on W1″ and outputs the dechlorinated water W1′.

Since the filtration device 21 and the irradiation device 22 in the sub-system 20′ are mutually redundant with respect to dechlorination, the intermediate water W1″ will be sufficiently dechlorinated as long as the filtration device 21 performs properly. Thus, the dechlorinated water W1′, as produced by the irradiation device 22, may not differ from the intermediate water W1″ during proper operation of the filtration device 21. However, it is conceivable that the irradiation device 22 results in further dechlorination of the intermediate water W1″, so that the sub-system 20′ reduces the total chlorine well beneath what is required by the main sub-system 21′.

It is realized that the filtration device 21 and/or the irradiation device 22 may comprise additional components, such as pumps, valves, sensors, tanks, etc. In the illustrated example, it is assumed that the filtration device 21 is operable to generate one or more measurement signals S1 and receive one or more control signals C1 for controlling its operation. In some implementations, S1 and/or C1 may be omitted. The irradiation device 22 is operable to generate at least one measurement signal S2 and receive one or more control signals C2 for controlling its operation.

Since the filtration device 21 and the irradiation device 22 are separately configured to effectively remove chlorine in incoming water, there is no need for any additional equipment for chlorine removal in the dechlorination sub-system 20′. For example, there is typically no intervening equipment for chlorine removal along the water flow path between the filtration device 21 and the irradiation device 22.

In an alternative embodiment, not shown, the irradiation device 22 is installed upstream of the filtration device 21. Thus, the intermediate water W1″ is instead generated by the irradiation device 22 from the supply water W1 and conveyed via the connecting fluid line 20B to the filtration device 21, which generates the dechlorinated water W1′ from the intermediate water W1″.

It is currently believed to be beneficial to arrange the filtration device 21 upstream of the irradiation device 22, as shown in FIG. 3. An activated carbon bed is known to act as a nutrient-rich environment for microorganisms and may be considered as a key point of ingress for microorganisms into the remainder of the fluid circuit. UV irradiation is known to reduce microbial activity. Thus, by placing the irradiation device 22 downstream of the filtration device 21, the microbial load entering the main sub-system 20″ (FIG. 1C) may be reduced. This will safeguard the health of the patient and may also extend the life of downstream components in the WPA 20. Further, the filtration device 21 is likely to reduce the amount of suspended solids in the water that enters the irradiation device 22. Suspended solids may impair the performance of the irradiation device 22, for example by absorbing or deflecting the UV radiation or by fouling the irradiation device 22.

The presence of suspended solids may alternatively or additionally be mitigated by including a particle filter for removing particles, such as clay, silt and silicon, upstream of the irradiation device 22. The particle filter may be a sediment filter and may be configured to filter out micrometer-sized particles, and optionally large endotoxin molecules, from the passing water.

The provision of a dedicated particle filter may be particularly relevant if the irradiation device 22 is arranged upstream of the filtration device 21.

In some embodiments, a particle filter is integrated in the filtration device 21.

The control device 50 is configured to implement logic for controlling the dechlorination system 20′, and optionally the main sub-system 20″ (FIG. 1C). In the illustrated example, the control device 50 is configured to generate the control signals C1, C2 at least partly based on the sensor signals S1, S2. The control device 50 comprises a combination of processing circuitry 51 and memory 52. The memory 52 may store program instructions for execution by the processing circuitry 51 to implement the operation of the control device 50. The control device 50 comprises a signal interface 53A for input of the sensor signals S1, S2 and output of the control signals C1, C2. In the illustrated example, the control device 50 further comprises a signal interface 53B for receiving input data from an input device 54, for example a keyboard, mouse, microphone, touch screen, etc., and providing output data to a feedback device 55, for example, a display, speaker, projector, etc. The above-mentioned program instructions may be supplied to the control device 50 on a computer-readable medium, which may be a tangible (non-transitory) product (for example, magnetic medium, optical disk, read-only memory, flash memory, etc.) or a propagating signal. The processing circuitry may comprise a generic processor, for example a microprocessor, microcontroller, CPU, DSP (digital signal processor), GPU (graphics processing unit), etc., or a specialized processor, such as an ASIC (application specific integrated circuit) or an FPGA (field programmable gate array), or any combination thereof. The memory 52 may include volatile and/or non-volatile memory such as read only memory (ROM), random access memory (RAM) or flash memory.

FIG. 4A is a section view of an example irradiation module 22A for use in the dechlorination device 20′ of FIG. 3. The module 22A comprises a casing or housing 220 that defines a processing chamber 221 with one or more inlets or inlet ports 222 (one shown) and one or more outlets or outlet ports 223 (one shown). Incoming water enters the processing chamber 221 through the inlet(s) 222 and outgoing water leaves the processing chamber 221 through the outlet(s) 223. In the context of FIG. 3, the inlet 222 is coupled to receive the intermediate water W1″ from the connecting fluid line 20B, and the outlet 223 is coupled to provide the dechlorinated water W1′ to the connecting fluid line 20A. At least one source 224 (one shown) of UV radiation is arranged in the processing chamber 221. The UV source 224 is operable to generate UV radiation so as to irradiate at least part of the processing chamber 221 by a diverging beam, as indicated by dashed lines in FIG. 4A. The UV radiation thereby interacts with the fluid within the processing chamber 221. The UV source 224 may comprise any element capable of generating UV radiation, including but not limited to a light-emitting diode (LED), a laser diode, a fluorescent lamp, an incandescent lamp, a gas-discharge lamp, etc. To reduce power consumption and cost, the UV source 224 may comprise one or more LEDs or laser diodes. LEDs and laser diodes also have a small footprint, long operative life, and a well-defined emission spectrum. At least one UV sensor 225 (one shown) is arranged to generate a measurement signal S2 indicative of UV radiation intensity in the processing chamber 221. The signal values in the signal S2 may be given in any suitable unit, for example a voltage indicative of incident power or irradiance on the UV sensor 225. In the context of the present description, a measured intensity value may be given in the unit provided by the UV sensor 225, or in any other unit given by applying a conversion function on the signal values from the UV sensor 225. The UV sensor 225 may comprise any element responsive to UV radiation, including but not limited to a photodiode, phototransistor, photoconductive detector, phototube, photoelectric cell, etc. The UV sensor 225 may be arranged at any location that is directly or indirectly irradiated by the UV source 224. In the illustrated example, the UV sensor 225 is arranged opposite to the UV source 224. In other examples, the UV sensor 225 is arranged on the same side as the UV source 224 or is even physically combined into a package with the UV source 224.

The irradiation module 22A may be configured for continuous or intermittent processing. In intermittent processing, water is intermittently admitted into the chamber 221 for processing. In continuous processing, water is continuously conveyed through the chamber 221 while being processed. Continuous processing may require larger emitted (radiant) power of the UV source 224 but may increase the production rate of conditioned water W2 by the WPA 20.

The UV source 224 may be configured to generate UV radiation within a wavelength range of 100-400 nm. UV radiation is significantly absorbed by water molecules below 200 nm, and combined forms of chlorine have low absorption of UV radiation above about 350 nm. Thus, the UV source 224 may be configured to confine the generated UV radiation to the range of 200-350 nm. In some embodiments, the generated UV radiation is confined to the range of 200-280 nm.

FIG. 5 is a graph of the molar absorptivity 501 of dichloramine (NHC12) and the molar absorptivity 502 of monochloramine (NH₂Cl) as a function of wavelength. The molar absorptivity curves 501, 502 approximately correspond to the decomposition by photolysis of the respective substance as function of wavelength. In FIG. 5, dichloramine (curve 501) has an elevated absorptivity within a range of 275-315 nm with a local maximum at about 295 nm, and monochloramine (curve 502) has an elevated absorptivity within a range of about 225-275 nm with a local maximum at about 245 nm. It may be desirable to match the emission spectrum of the UV source 224 to the regions of elevated absorptivity in FIG. 5 to optimize the chlorine reduction efficiency of the module 22A. Three example emission spectra R1, R2, R3 for the UV source 224 are shown by dotted lines in FIG. 5. The spectrum R1 is approximately matched to the local maximum of curve 502 at about 245 nm and may result in maximum photolysis of monochloramine. The spectrum R2 is approximately matched to a local maximum of curve 501 at about 295 nm and may result in maximum photolysis of dichloramine. The spectrum R3 is approximately matched to an intersection of the curves 501, 502 at about 270 nm.

The selection of wavelength may also account for the absorptivity curves of dissolved hypochlorite ions and hypochlorous acid, which may be included as free form chlorine in the incoming water. According to literature data, both substances have broad ranges with elevated absorptivity: a range of about 220-255 nm with a local maximum at about 240 nm for hypochlorous acid, and a range of about 265-320 nm with a local maximum at about 290 nm for dissolved hypochlorite ions.

Depending on the emission properties of available UV emitting elements, it may be advantageous to combine at least two UV emitting elements with different emission spectra in the UV source 224. The emission spectra of different UV emitting elements may or may not overlap. In some embodiments, the UV emitting elements are configured to emit in different wavelength ranges, which may or may not be partly overlapping. In the example of FIG. 4A, the UV source 224 comprises three radiation-emitting elements L1, L2, L3, for example UV-LEDs, which are configured to generate emission spectrum R1, R2 and R3, respectively, in FIG. 5. In some embodiments, the respective UV emitting element is configured to generate an emission spectrum (cf. R1, R2, R3 in FIG. 5) with an approximate width (full width at half maximum, FWHM) in the range of 5-15 nm.

The irradiation module 24A may be designed for supply water W1 with a specific composition of total chlorine, through adaptation of the UV source 225. For example, in some regions, the supply water W1 contains low concentrations of dichloramines Also, the total chlorine may differ significantly between regions. Thus, the UV source 225 may be selected to have suitable emission properties for a specific region, for example in terms of output (radiant) power, wavelengths of the UV radiation, etc.

As understood from the foregoing, the irradiation module 22A may include a UV source 224 with two or more UV emitting elements, which are configured to emit UV radiation in at least partly different wavelength ranges, where the wavelength ranges may be selected to target decomposition of different chlorine substances in the water to be dechlorinated. In some embodiments, at least one UV emitting element is configured to primarily cause decomposition of monochloramine, and at least one UV emitting element is configured to primarily cause decomposition of free chlorine and dichloramine. This allows for optimization of the UV radiation from the UV source 224. In some embodiments, this is achieved by combined use of UV emitting elements that emit in a range of 240-265 nm and a range of 265-290 nm, respectively.

In some embodiments, the irradiation module 22A may be operated to selectively activate one or more of the UV emitting elements in the UV source 224 based on an expected composition of total chlorine in the supply water W1 to be dechlorinated. In some embodiments, the control device 50 will automatically and selectively activate one or more of the available UV emitting elements in the UV source 224 based on content data for the supply water (cf. step 601). The content data is made available to the control device 50 to indicate the composition of chlorine in the supply water.

UV irradiation is currently used as a disinfection method for drinking water treatment. The underlying mechanism is that the nucleic acid in microbes is damaged after absorbing the incident UV radiation. The present Applicant have conducted experiments that indicate that the radiant (emitted) power of the UV source needs to be increased by at least a factor of 10, possibly at least 15 or 20, to decompose chlorine in water in a conventional device that is configured for water disinfection by UV irradiation.

The filter module 21A in the dechlorination sub-system 20′ of FIG. 3 may be configured as in FIG. 2. However, since the irradiation module 22A provides redundancy in relation to the filter module 21A, it is conceivable to remove, or at least reduce, the internal redundancy of the filter module 21A. Thus, in some embodiments, the internal redundancy of the filter module 21A is less than 2, for example, in the range of 1.0-1.9, where an internal redundancy of 1.0 or 1.9 implies that the filter module 21A is designed to remove 100% or 190%, respectively, of a target quantity of total chlorine (cf. step 610 below).

The removal or reduction of redundancy may be implemented by removing one of the AC filters 100 in FIG. 2, or by reducing the filtration capacity of the respective AC filter 100 in FIG. 2, for example by using AC filters 100 containing a smaller amount of activated carbon 100A. This will reduce both the manufacturing cost and the operating cost of the filtration device 21, and thereby offset the added cost of the irradiation device 22. It is currently believed that the cost of the irradiation module 22A is comparable to the cost of a conventional AC filter 100. Given that the AC filters in the reference example are typically replaced 2-3 times a year, whereas the irradiation module 22A may have an operative life of several years, the novel concept actually enables considerable cost savings compared to the reference example in FIG. 2.

FIG. 4B shows an example of a filter module 21A with a single AC filter 100 containing a bed of activated carbon 100A. An inlet line 101 is fluidly connected to an inlet of the AC filter 100, and an outlet line 102 is fluidly connected to an outlet of the AC filter 100. In the illustrated example, supply water W1 is passed through the AC filter 100 to generate intermediate water W1″ (cf. FIG. 3).

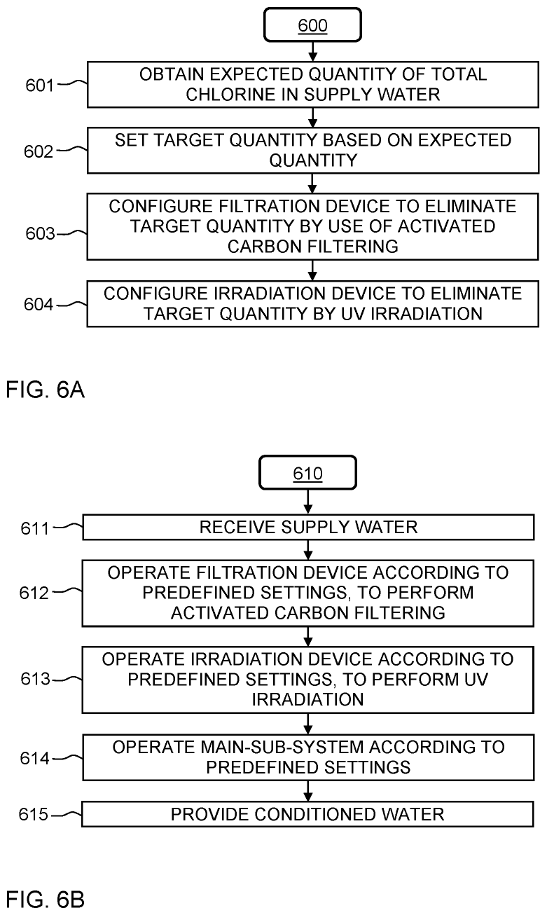

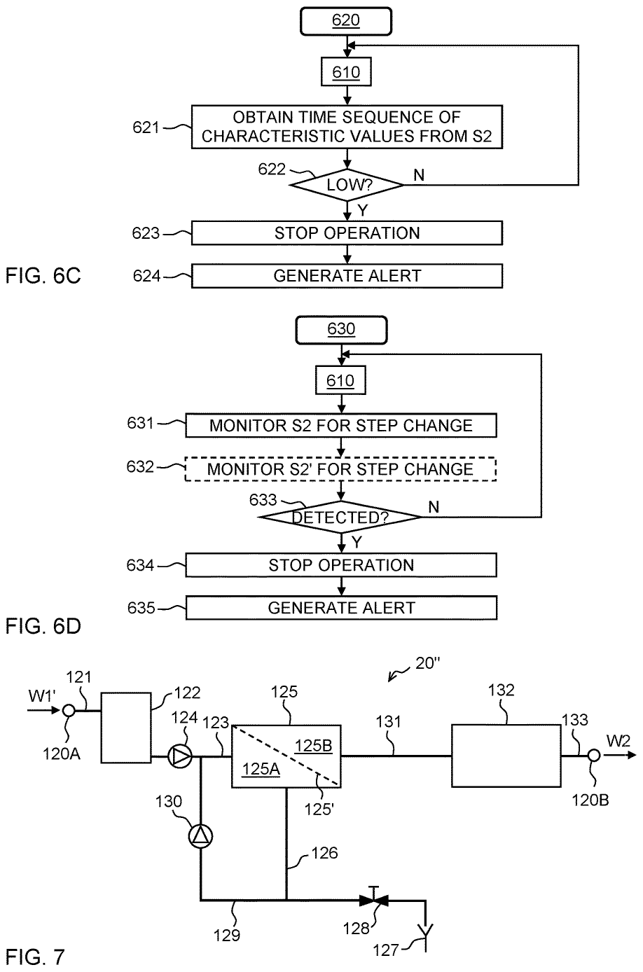

FIG. 6A is a flow chart of an example method 600 of configuring a dechlorination sub-system 20′ in accordance with an embodiment. The method 600 may be performed by a technician before deploying the sub-system 20′ or when designing the sub-system 20′. In step 601, an expected quantity (“design quantity”) of the total chlorine in the supply water W1 is obtained. The design quantity may be given by measurements or by nominal data. Step 601 may involve obtaining detailed content data about the chlorine content in the supply water, for example the relation between free forms and combined forms, or the composition of the free forms and/or the combined forms. In step 602, a target quantity of total chlorine to be removed from the supply water is determined, based on the design quantity, for example to meet predefined requirements of the dechlorinated water W1′. In step 603, the filtration device 21 is configured to eliminate the target quantity by use of activated carbon filtering. For example, the amount of active carbon 100A may be selected or the flow rate of supply water W1 may be adjusted in view of the target quantity, and in view of an internal redundancy selected for the filtration device 21. In step 604, the irradiation device 22 is configured to eliminate the target quantity by UV irradiation. For example, step 604 may involve adapting, for example, the number of UV sources 224, the radiant power, the emission spectrum of the UV source 224, the size of the chamber 221, etc., in view of the target quantity. In one example, the technician selects, among a plurality of different irradiation modules 22A, a suitable irradiation module 22A for installation in the irradiation device 22. Alternatively, if a single preconfigured irradiation module 22A is available, the technician may adapt the radiant power of the UV source 225 in view of the target quantity. The skilled person understands that the irradiation device 22A may also be configured in view of the above-mentioned detailed content data.

FIG. 6B is a flow chart of an example procedure 610 of operating the WPA 20 in FIG. 3. The procedure 610 may be performed by the control device 50 (FIG. 3). In step 611, the supply water W1 is admitted into the WPA 20. In step 612, the filtration device 21 is operated in accordance with predefined settings to pass the supply water through the activated carbon in the filter module 21A. The predefined settings may be given by step 603 of method 600. In step 613, the irradiation device 22 is operated in accordance with predefined settings to receive the intermediate water W1″ from the filtration device 21 and irradiate W1″ by UV radiation. The predefined settings may be given by step 604 of method 600. In step 614, the main sub-system 20″ is operated in accordance with predefined settings to receive and process the dechlorinated water W1′ into conditioned water W2. Thus, step 614 results in preparation of W2 based on W1′. Step 614 may be performed in accordance with conventional practice depending on the type of water purification equipment in the main sub-system 20″. In step 615, the conditioned water W2 is provided for use in medical treatment. The conditioned water W2 may be provided as a continuous stream from the WPA 20 or in batches.

It may be noted that, in addition to other advantages described herein, the irradiation device 22 will prevent spikes (“chlorine spikes”) in the chlorine concentration of the supply water W1 from affecting the dechlorinated water W1″. In some geographies, it is not uncommon for the total chlorine in the supply water W1 to exceed the design quantity (cf. step 601) from time to time, for example because of instabilities in the water preparation plant that generates W1. During a chlorine spike, the intermittent water W1″ may contain an elevated chlorine concentration, which will be reduced to an acceptable level by the irradiation device 22.

The Applicant has found that it is possible to monitor the status of the irradiation device 22 as such, based on the measurement signal S2 (FIGS. 3 and 4A). Experiments show that the signal S2 correlates with the radiant power of the UV source. Experiments also indicate that the signal S2 is affected by the state of the chamber 221. For example, deposits on the UV source 224 and the UV sensor 225 in the chamber 221 may decrease the signal S2. Thus, the control device 50 may operate on the signal S2 to detect a need for maintenance of the irradiation device 22.

FIG. 6C is an example method 620 for monitoring the operational status of the irradiation device 22 in accordance with an embodiment. The method 610 may be performed by the control device 50 (FIG. 3). In the method 620, the WPA 20 is operated in accordance with the procedure 610. During operation of the WPA 20, steps 621-622 are executed, for example at regular time intervals, to monitor the performance of the irradiation device 22. In step 621, characteristic values are derived from one or more measurement values in the measurement signal S2. The respective characteristic value represents the UV radiation intensity on the UV sensor 225. For example, the characteristic value may be given by a single measurement value, a time-average of a plurality of measurement values, a low-pass filtered value, etc. The characteristic value may be converted into a unit for UV radiation intensity. Alternatively, the characteristic value may be given in a unit provided by the UV sensor 225, for example a voltage. The characteristic values from step 621 form a time sequence of values. In step 622, the time sequence of values is evaluated in relation a detection criterion for detection of a malfunction of the irradiation device 22. If the detection criterion is not fulfilled, the operation of the WPA 20 is continued and step 622 causes step 621 to be performed at a future time point. If the detection criterion is fulfilled, step 622 causes the operation of the WPA 20 to be stopped (by step 623) and an alert to be generated (by step 624). The alert is indicative of a malfunction of the irradiation device 22. The malfunction may, for example, be that the radiant power of the UV source 224 is too low or that there is too much deposit or other fouling within the chamber 221. In step 624, the feedback device 54 (FIG. 3) may be operated to provide an alarm signal, information about the cause for the stopped operation, or an instruction to the operator. For example, the operator may be instructed to inspect or perform maintenance of the irradiation device 22.

During such maintenance, the irradiation module 22A may be replaced and/or serviced. Further, the performance of the filtration device 21 may be evaluated during the maintenance, by taking a sample of W1″ downstream of the filtration device 21 and analyzing the sample for chlorine. If total chlorine is elevated, the filter module 21A of the filtration device 21 may be replaced. Alternatively, the filter module 21A may be replaced by default whenever the irradiation module 22A needs maintenance. It is realized that the number of samples that need to be taken and analyzed is significantly reduced compared to the reference example in FIG. 2.

It is understood that the method 620 is performed under the assumption that the filtration device 21 performs properly.

In some embodiments, step 622 comprises comparing the respective characteristic value to an intensity limit, and the detection criterion may be fulfilled if a predefined number (N) of characteristic values is below the intensity limit, with N≥1. The intensity limit may be set to ensure that the irradiation device 22 is operable to eliminate the target quantity (cf. step 602) when the characteristic value is above the intensity limit. The intensity limit may be determined in a validation procedure, in which an irradiation module 22A is tested under well-controlled conditions. The validation procedure may involve measuring characteristic values and analyzing the content of chlorine in the processed water, for source water with a reference concentration of total chlorine and for one or more radiant powers of the UV source.

Depending on the malfunction, the change in characteristic values may be slow or fast. A gradual fouling of the chamber 221 or a gradual degradation of the UV source 224 may result in a slow change, whereas a complete loss of radiant power of one or more radiation-emitting elements in the UV source may result in a fast change. Thus, the control device may be configured to output different information/instructions depending on a characteristic of the detected change.

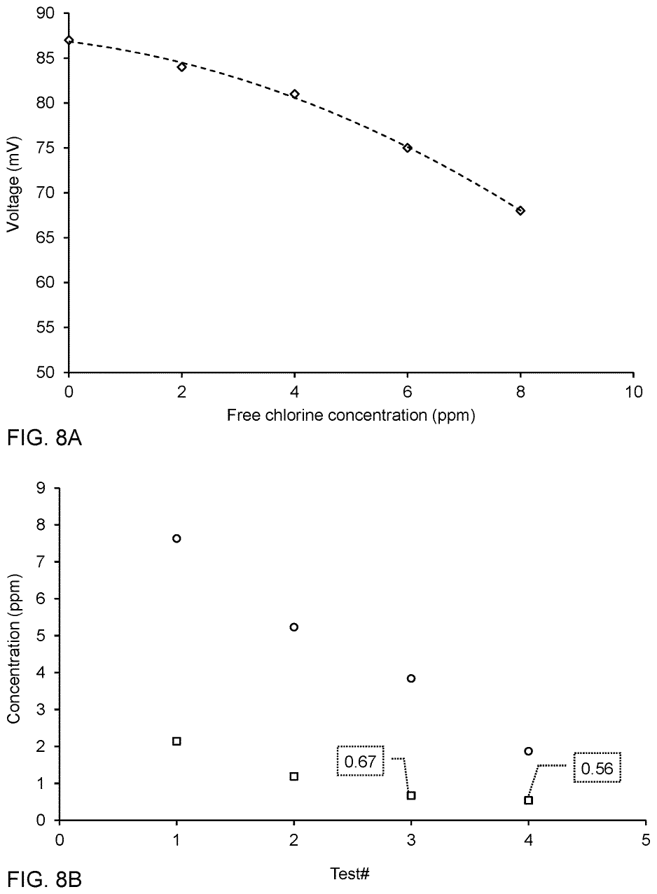

After significant experimentation, the Applicant has identified an opportunity for online monitoring of the performance of the filtration device 21, specifically to detect the occurrence of channeling. FIG. 8A shows an example of experimental results obtained for an irradiation device configured to emit UV radiation at 280 nm. The irradiation device was supplied with water containing 0, 2, 4, 6, or 8 ppm of free chlorine, and the average signal level (here, a voltage) in the measurement signal S2 was measured. FIG. 8A thus shows the measured signal level for different amounts of free chlorine in the incoming water. FIG. 8A includes a trend line (dashed), which is a polynomial fit to the measurement data. As seen, the signal level of S2 decreases monotonically with increasing amount of free chlorine. The decrease is the result of absorption of UV radiation by free chlorine. Similar results are expected for monochloramine, when the wavelength of the UV radiation is properly matched to the absorptivity of monochloramine (FIG. 5). Channeling in the filtration device 21 is expected to result in a rapid increase in the concentration of total chlorine downstream of the filtration device 21, for example from below 0.1 ppm to 2-4 ppm depending on the concentration of total chlorine in the supply water W1. Given FIG. 8A, such an increase will result in a detectable step-change in the measurement signal S2.

The ability of the above-mentioned irradiation device to remove free chlorine from incoming water has also been tested. The concentration of free chlorine was concurrently measured in incoming water to and outgoing water from the operating irradiation device. The experiment was conducted for different concentrations of free chlorine in the incoming water. The result is presented in the graph of FIG. 8B. As shown, the concentration of free chlorine is drastically decreased through the operation of the irradiation device 22. Similar results are expected for monochloramine and dichloramine. Given the limitation of the experimental setup, it is foreseen that the concentration of total chlorine in the outgoing water can be reduced to or below 0.1 ppm, by straight-forward optimization of the radiant power of the UV source in the irradiation device 22 and/or the wavelengths of the UV radiation, for example as discussed above with reference to FIG. 5. This experiment indicates, as expected, that the irradiation device 22 is capable of effectively removing chlorine from the supply water W1.

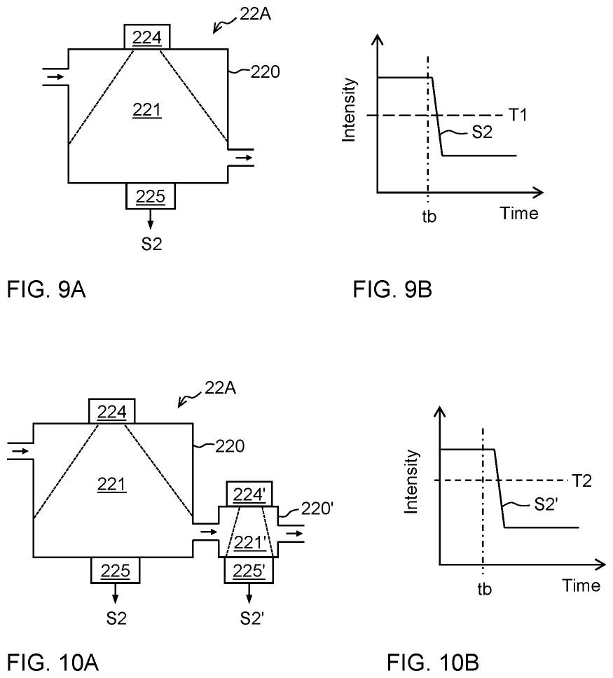

FIG. 6D is an example method 630 for monitoring the operational status of the filtration device 21 in accordance with embodiments. The method 630 may performed by the control device 50 (FIG. 3). The method 630 will first be described for the irradiation module 22A in FIG. 9A, which is similar to the module 22A in FIG. 4A. In the method 630, the WPA 20 is operated in accordance with the procedure 610. During operation of the WPA 20, step 631 is executed, for example at regular time intervals, for detection of a step-change decrease in the measurement signal S2. FIG. 9B shows an example of such a step-change, which occurs when a channel is formed in the filtration device 21, at time tb, causing the device 21 to provide water with an elevated chlorine concentration to the irradiation device 22. The step-change may be detected in any suitable way in step 631, for example by detecting that measured intensity falls below an intensity threshold T1, as shown in FIG. 9B. The threshold T1 may be predefined or set in relation to a dynamic reference level, which may be given by the most recently measured intensity values in S2, for example an average. Thus, in some embodiments of step 631, a reference level is determined at current time point as a function of preceding signal values in S2, the threshold T1 is set in relation to the reference level, and the signal level in S2 at the current time point is compared to T1. Alternatively or additionally, the step-change may be detected when a derivative of the measured intensity exceeds a derivative threshold. The derivative of the measured intensity may be determined by differentiation of the signal S2. The measured intensity may be given by the above-mentioned characteristic values (step 621 in FIG. 6C). Step 631 may also require the measured intensity to remain below T1 for a predefined time period before a step-change is deemed to have been detected.

If the step-change is not detected in step 631, the operation of the WPA is continued and step 633 causes the method 630 to perform step 631 at a future time point. If the step-change is detected, step 633 causes the operation of the WPA 20 to be stopped (step 634) and an alert to be generated (step 635). In step 635, the feedback device 54 (FIG. 3) may be operated to provide an alarm signal, information about the cause for the stopped operation, or an instruction to the operator. For example, the operator may be instructed to perform maintenance of the filtration device 21.

The method 630 provides a significant technical advance, since it allows for online monitoring of the performance of the filtration device 21. This will effectively eliminate the need to take and analyze samples of the intermediate water (cf. W1″ in FIG. 3 and FIG. 4A).

It may also be noted that the above-mentioned intermittent spike of chlorine concentration in the supply water W1 is likely to be visible in the measurement signal S2. The method 630 may or may not be designed to discriminate between a signal feature originating from an intermittent spike in the supply water W1 and a step-change caused by channeling, for example based on a difference in derivative and/or magnitude and/or duration.

As indicated by a dashed box in FIG. 6D, the method 630 may comprise a step 632 of monitoring a further measurement signal S2′ for detection of a step-change. Step 632 is based on an insight derived from the experimental data in FIG. 8B. The experimental data shows that the concentration of free chlorine in the outgoing water (squares in FIG. 8B) decreases monotonically with decreasing concentration of free chlorine in the incoming water (circles in FIG. 8B). By jointly considering the data in FIGS. 8A-8B, this means that a step-wise increase in the chloride concentration of the incoming water to the irradiation device 22, caused by channeling in the filtration device 21, will not only result in a step-wise decrease of the signal level in S2 and but also an increase in the chloride concentration of the outgoing water. By detecting this concentration increase, an improved certainty of channeling detection may be achieved.

The signal S2′ may be provided by an irradiation module 22A as shown in FIG. 10A. A further UV sensor 225′ is arranged downstream of the chamber 221 to receive UV radiation generated by a further UV source 224′. In the illustrated example, the further UV source 224′ and the further UV sensor 225′ are arranged in a further chamber 221′, which is defined by a further housing 220′ and is fluidly connected to the output ports(s) of the housing 220. The illustrated placement is merely given as an example, and the further UV sensor 225′ may be arranged at any location that is directly or indirectly irradiated by the further UV source 224′. The further housing 220′ may be a separate measurement unit or an integrated part of piping extending from the outlet(s). The further UV source 224′ may, but need not, be identical to the UV source 224. It is conceivable that the UV source 224′ emits UV radiation at (partly) different wavelengths than the UV source 224. Compared to the UV source 224, the radiant power of the further UV source 224′ may be lower since its purpose is not dechlorination but measurement of remaining total chloride in the water that has passed the chamber 221. FIG. 10B shows an example of a step-change decrease in the measurement signal S2′ as a result of channel formation in the filtration device 21 at time tb. As seen, there may be a delay from the time tb until water with increased chloride concentration reaches the chamber 221′. The step-change in the signal S2′ may be slower than the step-change in signal S2, depending on the degree of mixing in the chamber 221. Following a channel formation, it is likely that the chamber 221 contains water from both before and after the channel formation. With increasing mixing in the chamber 221, a more gradual decrease in signal level (slower step-change) may be detected by the UV sensor 225′ as the water flows from chamber 221 into chamber 221′.

The step-change decrease may be detected in step 632 by analogy with step 631. In some embodiments, the step-change is detected when the measured intensity in the signal S2′ falls below an intensity threshold T2, as shown in FIG. 10B. Similar to the threshold T1, the threshold T2 may be predefined or set in relation to a dynamic reference level. Step 633 may also require the measured intensity to remain below T2 for a predefined time period before a step-change is deemed to have been detected.

Step 633 may be configured to logically combine the outcomes of steps 631 and 632 to determine if the method 630 should proceed to step 634 or not. It is thereby possible to mitigate the risk of false positives in the determination by step 633.

In some embodiments, step 633 applies a logic AND between the outcomes of step 631 and 632, so that step 633 only proceeds to step 634 when time-synchronized step-changes are detected in both signals S2, S2′. For example, step 633 may require the step-changes to occur in S2 and S2′ within a predefined time period. In other embodiments, step 633 applies a logic OR between the outcomes of step 631 and 632, so that step 633 proceeds to step 634 when a step-change is detected in at least one of the signal S2 and the signal S2′ within a predefined time period. It is also conceivable that step 633 is switched between applying logic AND or logic OR. In one example, step 633 may use logic AND by default and switch to logic OR when the confidence of the detection by step 631 or step 632 is low. For example, step 631 and/or step 632 may provide a confidence value of each detected step-change. The confidence value may be given by a magnitude of the signal decrease during the step-change and/or a derivative of the step-change.

FIG. 7 is a schematic view of an example main sub-system 20″. FIG. 7 is merely given to provide further context and is not intended to limit the present disclosure in any way. The main sub-system 20″ comprises an inlet 120A for dechlorinated water W1′, and an outlet 120B for conditioned water W2. An inlet line 121 extends from the inlet 120A to a tank 122 for intermediate storage of dechlorinated water. A connecting line 123 extends from the tank 122 to the feed side 125A of an RO module 125. The RO module 125 is of conventional structure and comprises an RO membrane 125′ that separates the RO module 125 into the feed side 125A and a permeate side 125B. The RO membrane 125′ may be a semi-permeable membrane. The RO module 125 is configured to remove impurities from the dechlorinated water, such as microorganisms, pyrogens and ionic material by the effect of reverse osmosis. A fluid pump 124 is arranged in the connecting line 123. A drain line 126 extends from the feed side 125A to a drain 127. In the illustrated example, an on/off valve 128 is arranged in the drain line 126, and a return line 129 extends from the drain line 126 upstream of the valve 128 to the connecting line 123 downstream of the fluid pump 124. A further fluid pump 130 is arranged in the return line 129. A connecting line 131 extends from the permeate side 125B to a post-processing module 132.

In operation, the pump 124 is activated to drive dechlorinated water from the tank 122 into the feed side 125A of the RO module 125, so as to apply a sufficient pressure to overcome the osmotic pressure. Thereby, the incoming stream of dechlorinated water, called feed water, is divided into reject water on the feed side 125A and purified water (permeate water) on the permeate side 125B. In a first mode of operation, the valve 128 is open and the reject water is conveyed along the drain line 126 to the drain 127. In a second mode of operation, the valve 128 is closed and the pump 130 is activated, so that the reject water is recirculated back to the connecting line 123 and pumped back into RO module 125. The recirculation increases the feed flow to the RO module 125 to reduce scaling and fouling of the RO membrane 125′. The RO module 125 may be switched between the first and second operating modes as appropriate. In a third operating mode, the reject water is divided into a stream of reject water that is recirculated by the pump 130 and a stream of drain water that is at the same time passed to drain 127 by opening the valve 128 an appropriate degree or with an appropriate interval. The resulting permeate water is conveyed in the connecting line 131 to the post-processing module 132.

The post-treatment module 132 is configured to polish the permeate water in order to further remove ions from the permeate water, resulting in conditioned water W2, which is provided to the outlet 120B on the outlet line 133. The permeate water is polished using a polisher device such as an electrodeionization (EDI) device, an ion exchanger device such as a mixed bed filter device, or an RO module. The mixed bed filter device comprises a column, or container, with a mixed bed ion exchange material.

The post-treatment module 132, or another module downstream the post-treatment module 132, may also include ultrafiltration to remove bacteria and endotoxins. One or more ultrafilters may then be utilized.

While the subject of the present disclosure has been described in connection with what is presently considered to be the most practical embodiments, it is to be understood that the subject of the present disclosure is not to be limited to the disclosed embodiments, but on the contrary, is intended to cover various modifications and equivalent arrangements included within the spirit and the scope of the appended claims.

Further, while operations are depicted in the drawings in a particular order, this should not be understood as requiring that such operations be performed in the particular order shown or in sequential order, or that all illustrated operations be performed, to achieve desirable results.

1-30. (canceled)

31. An apparatus for preparing water for use in medical treatment of a human or animal body, said apparatus being configured to receive supply water from a water source and comprising:
a pre-processing sub-system comprising:
a filtration device comprising one or more activated carbon filters; and
an irradiation device connected in series to sequentially process the supply water into dechlorinated water, wherein the filtration device is configured to effectively remove chlorine in the supply water using the one or more activated carbon filters, and wherein the irradiation device is configured to effectively remove the chlorine in the supply water by ultraviolet (UV) irradiation so that the filtration device and the irradiation device are mutually redundant with respect to dechlorination; and
a main sub-system arranged to receive the dechlorinated water from the pre-processing sub-system and configured to process the dechlorinated water to generate conditioned water to be used in medical treatment.

32. The apparatus of claim 31, wherein the irradiation device comprises:
a casing defining a processing chamber;
an inlet to the processing chamber for incoming water;
an outlet from the processing chamber for outgoing water; and
at least one source of UV radiation arranged to irradiate at least part of the processing chamber.

33. The apparatus of claim 32, wherein the irradiation device further comprises at least one sensor arranged to generate a measurement signal indicative of UV radiation intensity in the processing chamber,
wherein the apparatus further comprises a control device configured to receive the measurement signal and monitor operation of at least one of the irradiation device or the filtration device based on the measurement signal.

34. The apparatus of claim 33, wherein the control device is configured to:
evaluate, based on the measurement signal, the UV radiation intensity in the processing chamber in relation to an intensity limit; and
generate, when the UV radiation intensity falls below the intensity limit, an alert indicative of a malfunction of the irradiation device.

35. The apparatus of claim 33, wherein the at least one source of UV radiation comprises a first radiation-emitting element and a second radiation-emitting element, wherein each of the first and second radiation-emitting elements are configured to emit UV radiation in different wavelength ranges than each other, and wherein the control device is further configured to activate the first radiation-emitting element, the second radiation-emitting element, or both of the first and second radiation-emitting elements to remove the chlorine in the supply water.

36. The apparatus of claim 35, wherein the control device is further configured to selectively activate at least one of the first and second radiation-emitting elements based on input data representing a composition of the chlorine in the supply water.

37. The apparatus of claim 35, wherein the first radiation-emitting element is configured to preferentially remove monochloramine over free chlorine and dichloramine, and the second radiation-emitting element is configured to preferentially remove free chlorine and dichloramine over monochloramine.

38. The apparatus of claim 35, wherein the first radiation-emitting element is configured to generate UV radiation with a peak in a first wavelength range of 240-265 nanometers (nm), and the second-emitting element is configured to generate UV radiation with a peak in a second wavelength range of 265-290 nm.

39. The apparatus of claim 33, wherein the control device is further configured to:
detect channel formation in the one or more activated carbon filters of the filtration device based on the measurement signal; and
generate an alert signal upon detection of the channel formation.

40. The apparatus of claim 39, wherein the control device, to detect the channel formation, is further configured to evaluate the measurement signal for detection of a step-change decrease in the measurement signal.

41. The apparatus of claim 40, wherein the control device is further configured to detect the step-change decrease by comparing a signal level in the measurement signal to a threshold value.

42. The apparatus of claim 41 wherein the control device is further configured to, at a current time point:
determine a reference level as a function of preceding signal values in the measurement signal;
set the threshold value in relation to the reference level; and
compare the signal level in the measurement signal at the current time point to the threshold value.

43. The apparatus of claim 39, wherein the irradiation device comprises a downstream UV radiation source and a downstream sensor, which are arranged downstream of said at least one source of UV radiation and said at least one sensor, wherein the downstream sensor is arranged to generate a downstream measurement signal indicative of UV radiation intensity received from the downstream UV radiation source, and wherein the control device is further configured to detect the channel formation based on the measurement signal and the downstream measurement signal.

44. The apparatus of claim 43, wherein the control device, to detect the channel formation, is further configured to evaluate the downstream measurement signal for detection of a downstream step-change decrease in the downstream measurement signal.

45. The apparatus of claim 44, wherein the control device is further configured to generate the alert signal when the downstream step-change decrease in the downstream measurement signal is detected in time synchronization with a corresponding step-change decrease in the measurement signal.

46. The apparatus of claim 31, wherein the main sub-system comprises at least one of:
reverse osmosis equipment; and
ion exchange equipment.

47. The apparatus of claim 31, wherein the filtration device and the irradiation device are connected in series without intervening processing equipment for removal of chlorine.

48. The apparatus of claim 31, wherein the irradiation device is configured to remove a first target quantity of the chlorine in the supply water, and wherein the filtration device is configured to remove a second target quantity of the chlorine in the supply water, wherein the second target quantity is at least equal to the first target quantity and less than twice the first target quantity.

49. A system comprising the apparatus for preparing water in accordance with claim 31 and a dialysis apparatus fluidly connected to receive the conditioned water from the apparatus for preparing water.

50. A method of preparing water for use in medical treatment of a human or animal body, said method comprising:
receiving supply water from a water source;
operating a filtration device and an irradiation device, which are connected in series in a pre-processing sub-system, to sequentially process the supply water into dechlorinated water, wherein the filtration device is configured to effectively remove chlorine in the supply water by filtration through activated carbon, and wherein the irradiation device is configured to effectively remove the chlorine in the supply water by ultraviolet (UV) irradiation so that the filtration device and the irradiation device are mutually redundant with respect to dechlorination;
operating a main sub-system in accordance with predefined settings to receive and process the dechlorinated water into conditioned water; and
providing the conditioned water for use in the medical treatment.
